(19) United States
(12) Patent Application Publication
(10) Pub. No.: US 2001/0055361 A1
(43) Pub. Date: Dec. 27, 2001

(54) Loading/unloading method, a crane rotating apparatus, and a hoisting apparatus

(76) Inventors: Hiroshi Hasegawa, Hitachi (JP); Kouichi Ushiroda, Hitachi (JP); Ryouhei Miyahara, Hitachi (JP); Youichi Yamane, Hitachi (JP); Masatoshi Yoshizaki, Sayama (JP)

Correspondence Address: MATTINGLY, STANGER & MALUR P.C., 104 EAST HUME AVENUE, ALEXANDRIA, VA, 22301, US

(21) Appl. No.: 09/790,675

(22) Filed: Feb. 23, 2001

(30) Foreign Application Priority Data
Apr. 20, 2000 (JP) 2000-126227

(51) Int. Cl. G21C 1/04; B66C 13/00

(52) U.S. Cl. 376/260; 376/347; 414/560; 414/800

(57) ABSTRACT

A method of placing cranes 1 and 2 with a reactor pressure vessel 4 (load) on a turntable 41 in the solid ground 57, turning the turntable 41 together with the cranes 1 and 2, and thus moving the reactor pressure vessel 4 to a selected position. Transferring an object by turning around a crane with a load in a narrow area without operating the crane.

### DESCRIPTION OF THE INVENTION

1. Field of the Invention The present invention relates to a method of loading and unloading heavy and bulky objects, a loading/unloading facility, and a rotating apparatus.

2. Prior Art

One or more cranes are used to lift and move components of a nuclear power plant into or out from the building of the nuclear power plant. As the components become greater and heavier, the cranes for them also become bulkier and heavier. It is very hard to operate such a bulky and heavy crane in a limited narrow place

Further when the crane tries to turn around horizontally with a product on it, the crane or the ground under the crane may be damaged because the product on the crane unbalances the crane.

To prevent the crane from being damaged, Japanese application patent laid-open publication No. 59-149849 (1984) discloses a method comprising the steps of placing the front crawler of the crane on a turn-table and moving the rear crawler horizontally. By horizontally rotating the turn-table, the front crawler of the crane can be smoothly turn around. This method facilitates horizontal orientation of the front crawler even when a heavy load is on the front crawler.

Japanese application utility model publication No. 60-114179 (1985) discloses a method of turning around a crane without a load. This method comprises the steps of laying part of the rails on which a crane runs on a table capable of rotating horizontally, causing the crane to run on the rails in place onto the table, and turning the table with the crane on it so that the crane may go to a selected direction.

The method of changing the directions of a crane disclosed in Japanese application utility model publication No. 60-114179 (1985) is employed to change directions of a crane when the crane moves from one working place to another working place. Substantially, the horizontally-rotatable table is provided in a place away from the working place. Therefore, Japanese application utility model publication No. 60-114179 (1985) does not provide a method and facility to change directions of a crane having a load.

The method disclosed by Japanese application patent laid-open publication No. 59-149849 (1984) is characterized by placing only the front crawler of the crane on a turn-table and moving the rear crawler horizontally. Therefore, the rear crawler must move a great distance with the front crawler as the center. This requires a wide area for the crane to run and operations to control the movement of the crawlers. Accordingly, the method disclosed by Japanese application patent laid-open publication No. 59-149849 (1984) is not suitable to change directions of a crane with a load in a limited narrow working space.

### SUMMARY OF THE INVENTION

Therefore, a basic object of the present invention is to change directions of a crane having a load on it without expanding the working space of the crane as much as possible.

Another object of the present invention is to provide facilities and articles required to attain said basic object.

A first means is a loading/unloading method which rotates a turn-table having a whole crane with a load to change positions of the load. When the turn-table having a crane with a load is rotated, the crane is turned around and the load hoisted by the crane can be oriented to a selected position. This method does not require any operation of the crane during this direction change and any additional space to change directions of the crane. For example, the radius of rotation of the crane is reduced by half with the center between the front and rear crawlers of the crane as the center of the rotation.

A second means is a loading/unloading method which rotates a turn-table having the whole cranes sharing a load to change positions of the load. When the turn-table having a plurality of cranes sharing a load is rotated, all cranes on the turn-table are simultaneously turned around by an identical quantity and the load hoisted by the cranes can be oriented to a selected position. This method does not require any operation of the cranes during this direction change and any additional space to change directions of the cranes. For example, the radius of rotation of the cranes is reduced with a point near the center between the front and rear crawlers of the cranes as the center of the rotation. Further, this method is available even when the load to be hoisted is extremely heavy because the load is hoisted by a plurality of cranes.

A third means is a loading/unloading method which places a whole crane on a float on the pool in the ground, causes said crane to hoist up a load, turns said float horizontally on the pool, and thus changes positions of the load. In accordance with this method, when the float having the crane with a load is rotated, the crane on the turn-table is turned around and the load hoisted by the crane can be oriented to a selected position.

This method does not require any operation of the crane during this direction change and any additional space to change directions of the crane. For example, the radius of rotation of the crane is reduced with the center between the front and rear crawlers of the crane as the center of the rotation. This method enables turning of a crane and change of positions of a load even in a narrow working space. Further, this method can rotate the float smoothly as the float is floating on the water.

A fourth means is a loading/unloading method which places the whole of a plurality of cranes sharing a load on a float on the pool in the ground, turns said float horizontally on the pool, and thus carries the load over a target position. In accordance with this method, when the float having the cranes with a load is rotated, all cranes sharing a load on the float are simultaneously turned around by an identical quantity and the load hoisted by the cranes can be oriented to a selected position. This method does not require any operation of the cranes during this direction change and any additional space to change directions of the cranes. For example, the radius of rotation of the cranes is reduced with a point near the center between the front and rear crawlers of the cranes as the center of the rotation. Further, this method is available even when the load to be hoisted is extremely heavy because the load is hoisted by a plurality of cranes. The float can rotate smoothly as it floats on the water.

A fifth means is a loading/unloading method which adjusts the weight of a common load hoisted up by a plurality of cranes in said second or fourth means. In addition to the aforesaid features of the second or fourth means, this method causes the cranes to share the hoisted load according to their loading capacities so that each crane may have a load under its loading capacity. In accordance with this means, the plurality of cranes need not be of the same performance.

A sixth means is a loading/unloading method which adjusts the buoyancy of the float to control the height of the top surface of the float above the water surface during the loading and unloading operations in the above third or fourth means. In addition to aforesaid features of the third or fourth means, this method can adjust the height of a crane on the float by controlling the buoyancy of the float. For example, this method can keep the crane on a constant height level even when the load on the crane changes.

A seventh means is a method of transferring nuclear power plant components between the top of the nuclear power plant building and the outside of the building, which comprises the steps of placing the whole cranes on a structure which can rotate horizontally, turning said structure, and transferring a nuclear plant component hoisted up by said cranes between the top of the nuclear power plant building and the outside of the building. In accordance with this method, all cranes on the structure turn around by an identical quantity simultaneously when the structure turns horizontally and the object hoisted by said cranes can be transferred anywhere between the top of the nuclear power plant building and the outside of the building without operating the cranes. In this case, for example, the radius of rotation of the crane is reduced with the center between the front and rear crawlers of the crane as the center of the rotation. So this method can turn around the cranes even in a limited narrow working space.

An eighth means is a method of transferring nuclear power plant components in accordance with the seventh means wherein said components are transferred into the nuclear power plant building. This means can transfer nuclear power plant components into the nuclear power plant building even in a limited narrow working space.

A ninth means is a method of transferring nuclear power plant components in accordance with the seventh means wherein components are transferred from the nuclear power plant building. This means can transfer nuclear power plant components from the nuclear power plant building even in a limited narrow working space.

A tenth means is a method of transferring a nuclear reactor comprising the steps of installing the whole cranes on a structure which can horizontally rotate on a ground near a nuclear reactor building, lifting up and down said reactor in said nuclear reactor building with said plurality of cranes, and horizontally turning said structure having said plurality of cranes on it together with said nuclear reactor to horizontally transfer said nuclear reactor to the outside of said nuclear reactor building. In accordance with this means, all cranes on the structure turn around by an identical quantity simultaneously when the structure turns horizontally and the nuclear reactor hoisted by said cranes can be transferred horizontally. Further as the nuclear reactor can be lifted up and down by a plurality of cranes, the nuclear reactor can be transferred to and from the nuclear reactor building without accordingly operations of the cranes. So this means can transfer the nuclear reactor to and from the nuclear reactor building even in a limited narrow working space.

An eleventh means is a method of transferring a nuclear reactor in accordance with the tenth means wherein said nuclear reactor is transferred into the nuclear reactor building. So this means can transfer the nuclear reactor into the nuclear reactor building even in a limited narrow working space.

A twelfth means is a method of transferring a nuclear reactor in accordance with the tenth means wherein said nuclear reactor is transferred from the nuclear reactor building. So this means can transfer the nuclear reactor from the nuclear reactor building even in a limited narrow working space.

A thirteenth means is a crane rotating apparatus comprising a horizontally-rotatable structure on which one or more cranes are installed, wherein the structure is 30 meters to 60 meters in diameter and can load 2,000 tons to 10,000 tons. Such a rotating apparatus is suitable to horizontally rotate cranes.

A fourteenth means is a crane rotating apparatus comprising a structure whose surface is wide enough to install the whole cranes for loading and unloading, wherein said structure can rotate horizontally on the solid ground. In accordance with this means, a plurality of cranes can be simultaneously turned around by an identical quantity as said cranes are placed on the structure. Therefore, a load hoisted by the plurality of cranes can be transferred accordingly to the rotation of the structure in a small radius of rotation without accordingly operations of the cranes.

A fifteenth means is a crane rotating apparatus comprising a pool in a solid ground and a float which can horizontally rotate in said pool and is wide enough to have a plurality of cranes thereon. In accordance with this means, a plurality of cranes can be simultaneously turned around by an identical quantity as said cranes are placed on the float. Therefore, a load hoisted by the plurality of cranes can be transferred accordingly to the rotation of the float in a small radius of rotation without accompanying operations of the cranes. Further, this method can rotate the float smoothly as the float is floating on the water.

A sixteenth means is a crane rotating apparatus in accordance with the fifteenth means, wherein said float is equipped with a buoyancy control means. In addition to the features of the fifteenth means, this means can adjust the height of the float by controlling the buoyancy of the float. This enables controlling the vertical positions of the cranes on the float.

A seventeenth means is a crane rotating apparatus in accordance with the sixteenth means, wherein said pool comprises a post around which said float can rotate and said post can extend and shrink vertically as said float moves up and down. In addition to the features of the sixteenth means, this means enables the post in the center of rotation of the float to extend and shrink vertically as the float moves up and down. Therefore, the float can rotate around the post regardless whether the float moves up and down.

An eighteenth means is a crane rotating apparatus in accordance with the fifteenth means, wherein said float has a plurality of areas whose buoyancies can be individually controlled. In addition to the features of the fifteenth means, this means enables the following: In other words, for example, in case the cranes are of the crawler type, when the front crawler of a crane rides on an area of the float and the float tilts, the float can be well-leveled to the ground by increasing the buoyancy of the float area on which the front crawler of the crane rides and decreasing the buoyancy of the float area which goes up. Further if the float lists when part of a crawler crane rides on the float, the float can be well-leveled to the ground so that the other part of the crane can ride on the float by controlling the buoyancies of a plurality of areas of the float.

A nineteenth means is a load-balancing hoisting apparatus comprising a balance beam having at least two horizontally-spaced joints with the cranes, a hoisting rod moving unit which can move horizontally on said balance beam, a hoisting rod which is hanging from said hoisting rod moving unit, and means for driving said hoisting rod moving unit horizontally. For use, the balance beam of the hoisting apparatus of the nineteenth means is suspended and supported by a plurality of cranes. When a load is connected to the hoisting rod, the driving means moves the hoisting rod moving unit with the hoisting rod along the balance beam. The hoisting load on the hoisting rod is shared by the cranes according to the position of the hoisting rod on the balance beam. In this manner, the hoisting load can be distributed and shared at a desired rate of loads by the cranes.

A twentieth means is a load-balancing hoisting apparatus in accordance with the nineteenth means, wherein said load-balancing hoisting apparatus is equipped with a unit for remotely controlling said driving means. In addition to the features of the nineteenth means, this means enables the following: That is, said remote control unit enables the operator at a remote place such as in a safety place away from cranes or in the operator room of a crane to control driving of the hoisting rod moving unit and distribute the load to the cranes.

A twenty-first means is a load-balancing hoisting apparatus in accordance with the nineteenth means, wherein said hoisting rod is mounted on said hoisting rod moving unit so that the hoisting rod can rotate horizontally. In addition to the features of the nineteenth means, this means enables the following: That is, as the hoisting rod can rotate horizontally on the balance beam, the horizontal rotation of the hoisting rod or the balance beam cannot be interfered.

### BRIEF DESCRIPTION OF THE DRAWINGS

FIG. 1 is a bird's eye view showing large crawler cranes lifting up a reactor pressure vessel from a vehicle, which is an embodiment of the present invention;

FIG. 2 is a bird's eye view showing large crawler cranes lifting down a reactor pressure vessel into a building, which is an embodiment of the present invention;

FIG. 3 is a magnified elevational view of a hoisting apparatus employed by an embodiment of the present invention;

FIG. 4 is a bottom view of the balance beam of the hoisting apparatus of FIG. 3;

FIG. 5 is a detailed schematic illustration of a hoisting rod moving unit of the hoisting apparatus of FIG. 3. FIG. 3 (a) shows the front view of the left half of a symmetrical hoisting rod moving unit of the hoisting apparatus of FIG. 3. FIG. 3 (b) shows the side view of the right half of a symmetrical hoisting rod moving unit of the hoisting apparatus of FIG. 3 (viewed perpendicularly to the movement of the unit);

FIG. 6 is a top view of a turntable employed as a rotating apparatus by the embodiment of the present invention with a partial view under the turn table;

FIG. 7 is a sectional side view of a turntable of FIG. 6 in which the right half of the figure is a view taken along the line VII-VII of FIG. 6;

FIG. 8 is a magnified view of rollers in the circled area A of FIG. 6;

FIG. 9 is a vertical sectional view of rollers of FIG. 8;

FIG. 10 is a top view of a float employed as a rotating apparatus which is another embodiment of the present invention;

FIG. 11 is a vertical sectional view of the rotating apparatus of FIG. 10 in which the right half is a float having a large crawler crane on it and the left half is a float having nothing on it; and

FIG. 12 is a bird's eye view showing a large crawler crane lifting down a reactor pressure vessel into a building, which is another embodiment of the present invention.

### DESCRIPTION OF THE INVENTION

Below will be explained the present invention using, as an example, a method of transferring components of a nuclear power plant in construction of a nuclear power plant by a large-scale crawler crane.

The large crawler crane has a performance to load, transfer, and unload a reactor pressure vessel which is the heaviest component among components constituting a nuclear power plant. Therefore, some nuclear plant components such as apparatus, pipes, trays, bases, machines, and electric facilities sometimes together with steel frames and iron reinforcement bars are assembled into a module whose weight does not exceed the weight of the reactor pressure vessel so that the module can be handled by the large crawler crane.

As a recent tendency in construction fields, construction industries are suffering from requests to reduce construction terms and shortage of veteran workers which must be settled. One of measures to solve such problems is to assemble as many parts as possible in the factory and lessen assembling works on the site.

As for construction of a reactor pressure vessel, for example, such a countermeasure is to assemble reactor pressure vessel components such as a shroud in the REACTOR PRESSURE VESSEL inadvance in the factory. As for a module, such a measure is to assemble as many parts as possible into the module in advance in the factory.

However, such countermeasure will increase the weights of products and members to be transferred. In extreme cases, such products and members will not be handled by the large crawler crane.

One of actions to be taken for such problems is to provide a new large-scale crawler crane which has a higher hoisting ability. However, such a large crawler crane is extremely expensive in production cost and not easy to be operated on construction sites. Therefore, such a large crawler crane is not general.

Further, it is very difficult to run the crawlers of the large crawler crane to turn around the large crawler crane having a nuclear power plant component in a small working place surrounded with various objects. Further, unexpected excessive forces may be applied to the large crawler crane during turning-around.

Further, two large crawler cranes are used to move and lift a heavy and bulky object which cannot be lifted and moved by a single large crawler crane. However, it is very difficult to turn around the large crawler cranes sharing a load. This requires very complicated crawler operations and a wide running space.

The above description is for an example of building up a nuclear power plant. However, this is also true to replacement of large apparatuses and devices in the nuclear power plant for preventive maintenance.

Accordingly, it is required to turn around a large crawler crane(s) with a heavy load in a very small running place (without enlarging the space), to load a heavy load, transfer it to and from the nuclear power plant, and unload it, and to suppress the working space of the large crawler crane from expanding.

Below will be explained an embodiment of horizontally turning around a large crawler crane with a load without increasing the running space of the crane.

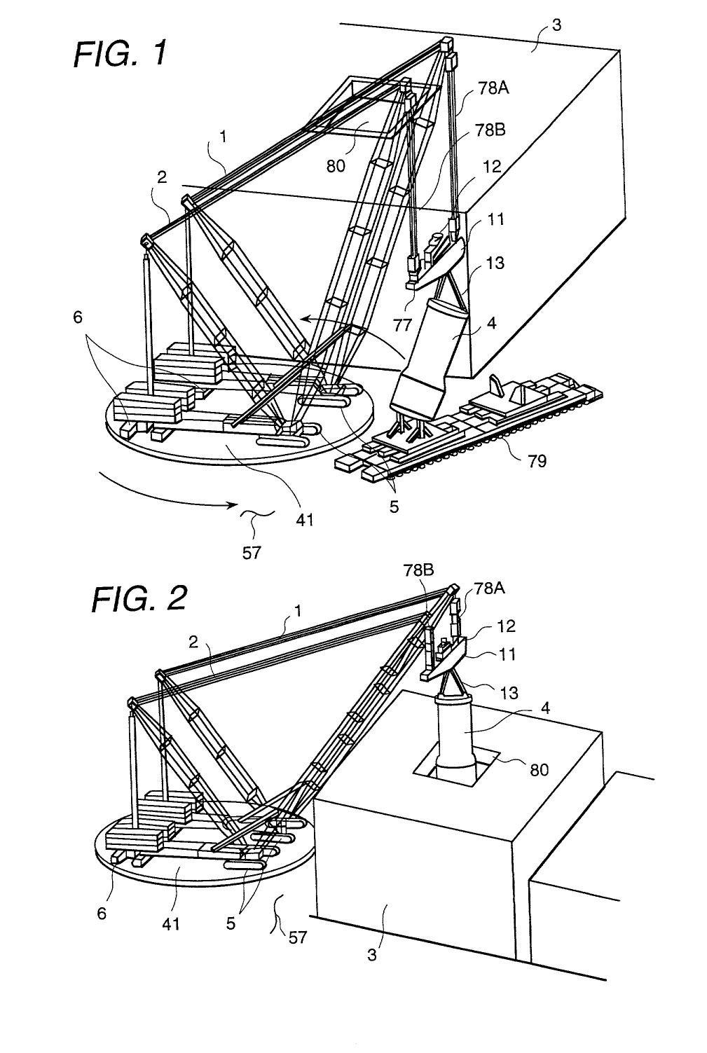

As seen in FIG. 1, a turntable 41 as a rotating apparatus which can rotate horizontally is installed on the ground 57 near a reactor building 3 in a boiling-water nuclear power plant. Two large crawler cranes 1 and 2 headed in the same direction are placed in parallel on the turntable 41. Each large crawler crane is assembled on the ground outside the rotating apparatus and carried onto the rotating apparatus by the front and rearcrawlers. Or each large crawler crane is assembled on the rotating apparatus with the front and rear crawlers on the rotating apparatus.

The two large crawler cranes 1 and 2 hold a hoisting apparatus 77 having a load balancing function. This hoisting apparatus 77 can be moved up and down by ropes 78A and 78B of the large crawler cranes 1 and 2.

In-reactor pressure vessel 4 structures such as a steam separator and a shroud are assembled in the reactor pressure vessel 4 in advance in the factory. The pre-assembled reactor pressure vessel 4 is laid flat on a vehicle 79 and carried from the factory to the reactor building 3 by vehicle 79 or ship.

When the reactor pressure vessel 4 vehicle 79 comes near the reactor building 3, the turntable 41 is horizontally rotated so that the hoisting apparatus 77 may hook the reactor pressure reactor 4 on the vehicle 79. Next, the hoisting apparatus 77 is moved down to the coupler 13 of the reactor pressure vessel 4 and linked to the coupler 13.

The hoisting apparatus 77 is pulled up to raise the reactor pressure vessel 4 as shown in FIG. 1, then pulled up further to lift up the reactor pressure vessel 4 completely from the vehicle 79.

Then the turntable 41 having the two large crawler cranes 1 and 2 is turned horizontally so that the reactor pressure vessel 4 suspended from the two large crawler cranes 1 and 2 may come over the reactor building 3. With this, the two large crawler cranes 1 and 2 are turned around simultaneously by the same quantity. In this quick and simple turning, the two large crawler cranes 1 and 2 need not be operated. The reactor pressure vessel 4 suspended from the two large crawler cranes 1 and 2 is moved horizontally towards the top of the reactor building as the turntable 41 rotates.

The reactor building has an opening 80 through which the reactor pressure vessel 4 can pass in the ceiling. The large crawler cranes 1 and 2 lowers the hoisting apparatus 77 so that the reactor pressure vessel 4 over the top of the reactor building 3 may pass through the opening of the building 3. The large crawler cranes 1 and 2 further lowers the hoisting apparatus 77 to position the reactor pressure vessel 4 on the pedestal in the reactor building 3.

The reactor pressure vessel 4 is settled in place on the pedestal, and uncoupled from the coupler. The hoisting apparatus 77 and the coupler 13 are hoisted up through the opening 80 toward the outside of the building 3.

As the reactor pressure vessel 4 settled on the pedestal already has internal components assembled, no more works on the reactor pressure vessel 4 are required such as transferring internal components into the reactor building and assembling the internal components in the rector pressure vessel 4. This shortens the time required to build up the nuclear power plant.

Further, the crawlers of the two large crawler cranes 1 and 2 need not be driven to turn around the two large crawler cranes 1 and 2 because the large crawler cranes are turned around simultaneously by rotation of the turntable 41. This does not require any wide running area to turn around the large crawler cranes 1 and 2.

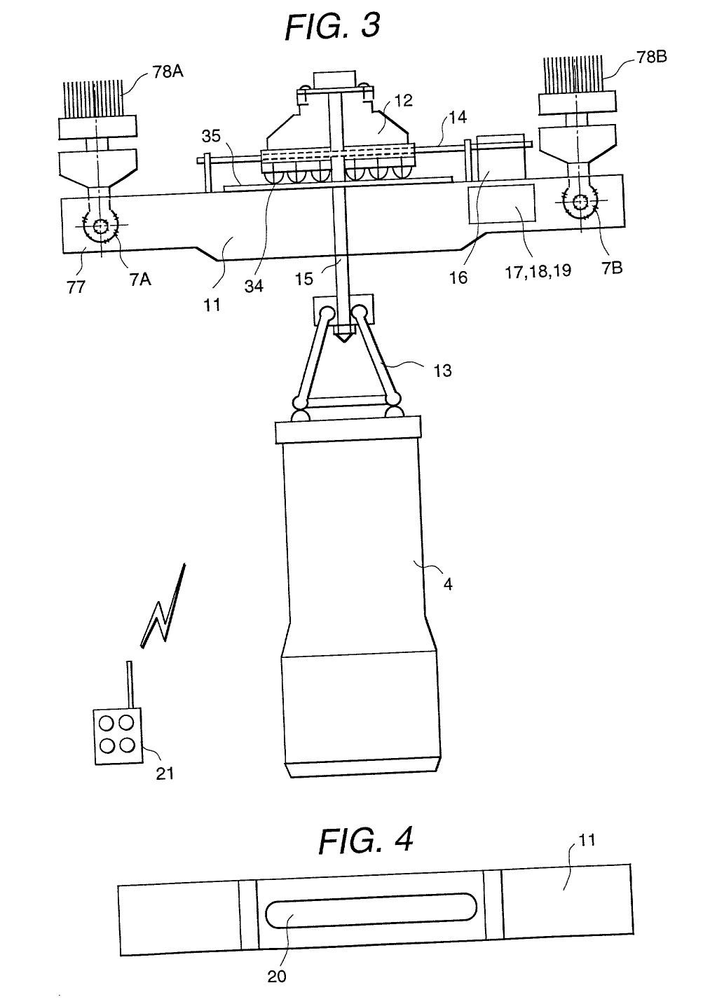

FIG. 3 shows a way how the reactor pressure vessel 4 is suspended from the hoisting apparatus 77. The hoisting apparatus 77 is constructed as explained below. A balance beam 11 of the hoisting apparatus has both ends suspended by ropes 78A and 78B of the two large crawler cranes through hooks 7A and 7B. When the hoisting apparatus 77 is used, the balance beam 11 is horizontally suspended by the two large crawler cranes 1 and 2.

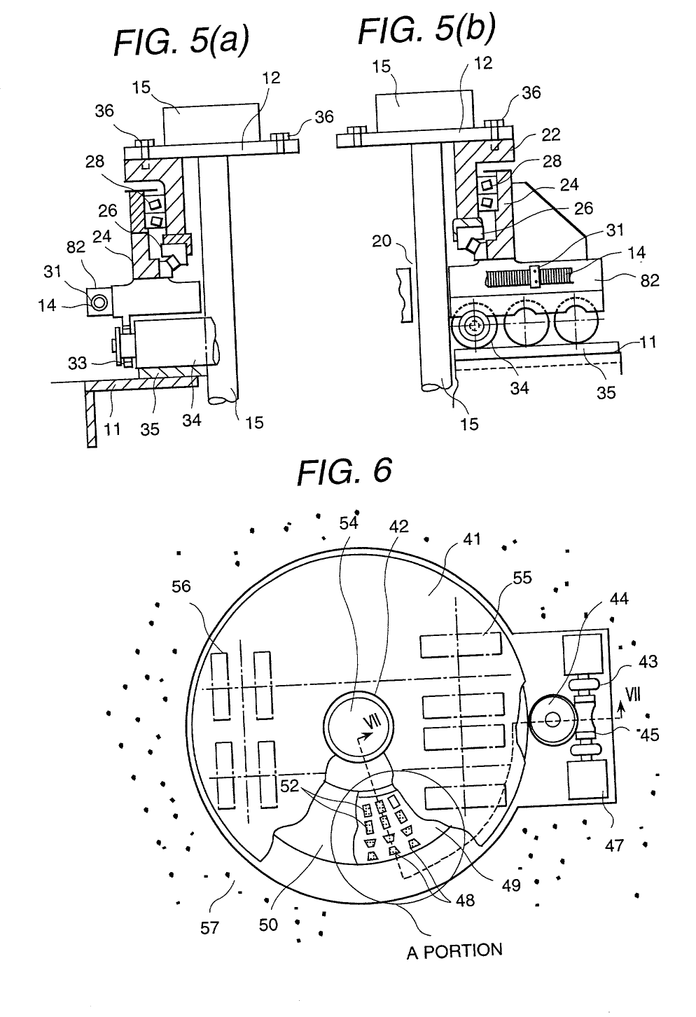

The balance beam 11 has a rail 35 laid on it. The roller-shaped wheels 34 of the hoisting rod moving unit 12 are on the rail 35 so that the hoisting rod moving unit 12 may move along the longitudinal axis of the balance beam 11. Referring to FIG. 5, a screw rod 14 driven by a gear motor 16 is engaged with a nut 31 fixed on the frame 82 of the hoisting rod moving unit 12 so that the screw rod 14 may be driven by the gear motor 16 on the balance beam 11. A battery 17 which supplies power to the gear motor 16, a unit 18 for controlling the gear motor 16, and a transmission means 19 which repeats signals from the remote controller 21 to the controller 18 are all provided on the balance beam 11. The radio remote controller 21 can remotely control the gear motor 16 through the transmission means 19 and the controller 18.

Therefore, the operator can rotate the gear motor 16 forward or backward or stop it by transmitting signals from the remote controller 21 to the controller 18 through the transmission means 19. When the gear motor rotates forward, the screw rod 14 rotates forward to move the nut 31 leftward (to the left of FIG. 3). As the result, the hoisting rod moving unit 12 moves left along the balance beam. When the gear motor, rotates backward, the hoisting rod moving unit 12 moves right along the balance beam.

The above driving method comprising a gear motor 16, a screw rod 14, and a nut 31 can be substituted by the other driving method such as chain driving, gear driving, wire (winch) driving, or oil-pressure cylinder driving.

The wheels 34 in the frame 82 of the hoisting rod moving unit 12 are mounted on the hoisting rod moving unit 12 by means of bearings 33. An outer casing 24 is mounted on the frame 82. An inner casing is mounted on the top of the outer casing 24 by means of a thrust bearing 26. Further the hoisting rod 15 is bolted (36) to the inner casing 22. The thrust bearing 26 enables the inner casing 22 to rotate horizontally even when the hoisting rod suspends a reactor pressure vessel 4. A bearing 28 is provided between the inner casing 22 and the outer casing 24 to prevent wobbling and shaking of these casings.

The hoisting rod 15 is connected to a hoisting rod moving unit 12 having wheels 34 so that the hoisting rod 15 and the hoisting rod moving unit 12 can horizontally move in a unit. As shown in FIG. 4, the balance beam 11 has a slot 20 for the hoisting rod 15 so that the hoisting rod 15 can move horizontally in the slot 20 along the balance beam 11.

As already described, the coupler 13 of the reactor pressure vessel 4 is connected to the lower end of the hoisting rod 15. As shown in FIG. 3, the reactor pressure vessel 4 is suspended from the hoisting apparatus 77. When the two large crawler cranes 1 and 2 have different loading capacities, the hoisting rod moving unit 12 is moved to control the horizontal position of the hoisting rod 15 so that the two large crawler cranes may have loads smaller than their loading capacities before the reactor pressure vessel 4 is connected to the hoisting rod 15. Next the reactor pressure vessel 4 is connected to the hoisting apparatus 77.

In some cases, the calculated loads on the two large crawler cranes 1 and 2 may not match the actual loads. In that case, after hoisting up the reactor pressure vessel 4, the operator remotely moves the hoisting rod moving unit 12 in the air by the remote controller 21 to adjust the rate of loads on the ropes 78A and 78B of the large crawler cranes 1 and 2.

In case the large crawler cranes 1 and 2 have the same loading capacity, usually the hoisting rod 15 is positioned in advance in the center of the balance beam 11.

FIG. 6 to FIG. 9 shows the structures of a turn-table 41 of a gear-driven type. The turn-table 41 is a steel disk or a circular steel frame covered with concrete which also works to prevent wheels from slipping. The turn-table is installed on the base 50 in the ground 57 with the center hole of the turn-table fit to the spindle 54 provided in the center of the base 50. A bearing 42 is provided between the turn-table and the spindle so that the turn-table may rotate horizontally around the spindle.

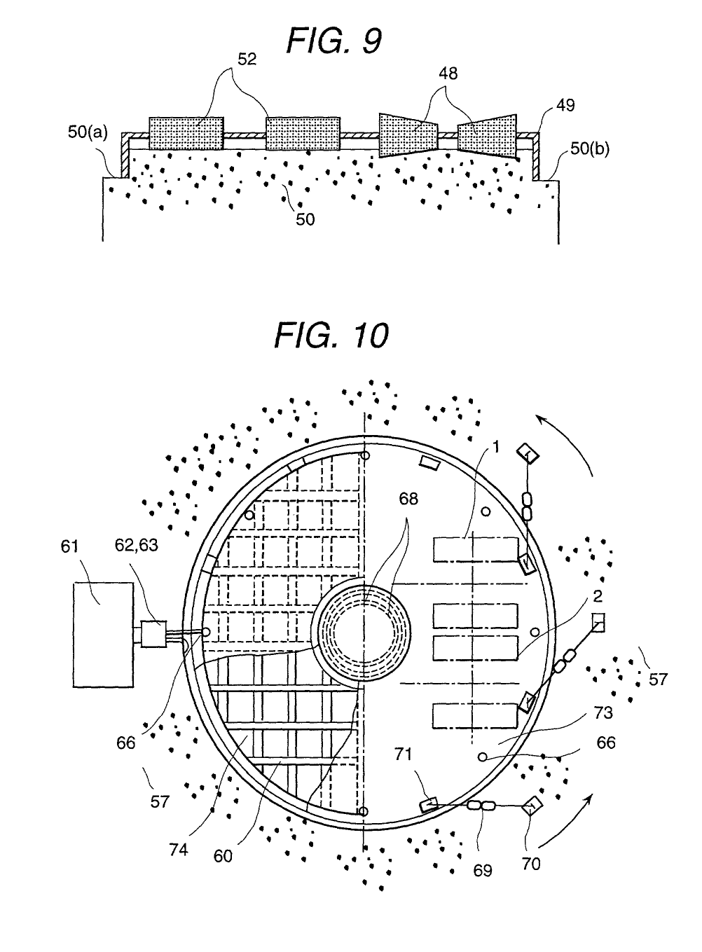

To rotate the turn-table 41 smoothly on the base 50, the base 50 has cylindrical rollers 52 and conical rollers 48 which support the vertical load of the turn-table 41. Referring to FIG. 8 and FIG. 9, the conical rollers 48 convert the vertical load of the turn-table 41 into horizontal and axial force components. These axial force components are opposite and cancelled as the conical rollers 48 are disposed axially. This prevents the turn-table 41 from deviating horizontally.

Referring to FIG. 8 and FIG. 9, a retaining disk 49 is place on the base 50 with the top of the retaining disk in the level of the centers of the cylindrical and conical rollers. The inner and outer edges of the retaining disk are respectively matched with the inner edge 50 (a) and the outer edge 50 (b) of the base 50 so that the retaining disk 49 can rotate on the base with the edges guided by the inner outer edges of the base 50.

The retaining disk 49 has a plurality of openings (through-holes) to respectively accommodate the cylindrical rollers 52 and the conical rollers 48. This enables the rollers 52 and 48 to turn in their openings of the retaining disk 49 while the turn-table 41 over the rollers rotate. Thus the turn-table 41 can rotate smoothly.

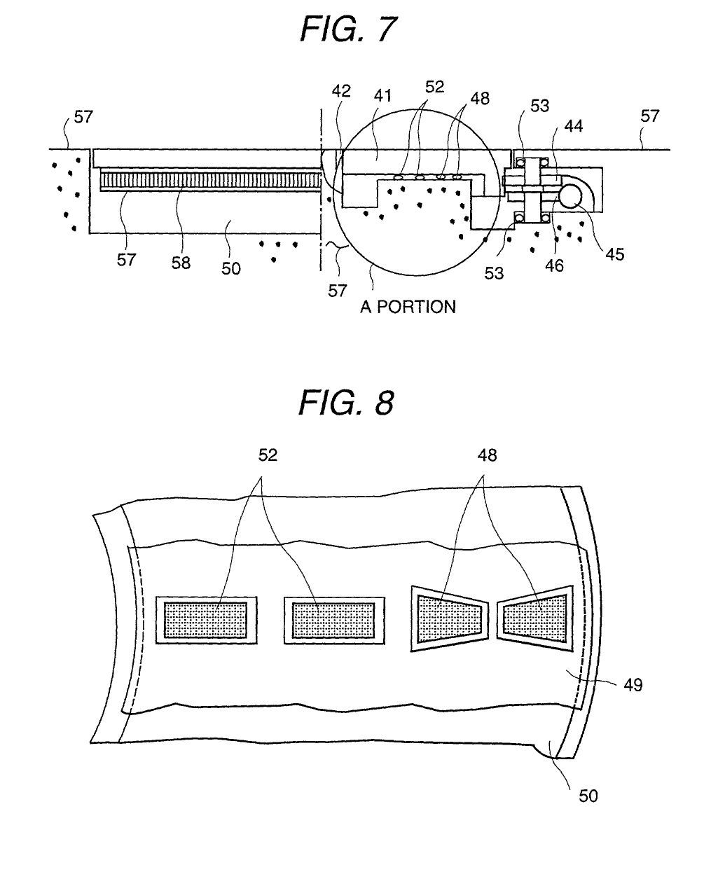

Referring to FIG. 6 and FIG. 7, the outer periphery of the turn-table 41 is toothed to form a rack with which a spur gear 44 working as a pinion is engaged. The spur gear is provided to rotate around a spindle supported by bearings 53 on the ground. A worm wheel 46 is mounted on the spindle and engaged with a worm 45. The spindle of the worm 45 is coupled with shaft of a motor 47 through a shaft coupling box 43. The motor 47 drives the worm 45 and the worm 45 turns the turn-table 41. The worm 45 can prevent involuntary rotation of the turn-table 41.

Referring to FIG. 8, below will be explained another mechanism of driving the turn-table 41 which is another embodiment of the present invention. This driving mechanism is applied to a turn-table 41 which is a hollow steel float floating on the water. A water pool 75 (to be filled with water 72) is formed on the ground 57 near a reactor building and a post 67 is provided in the center of the pool with its lower end fixed to the bottom of the pool. A movable column 76 is fit to the post 67 with rollers 68 between the pole and the column so that the column 76 can rotate around the pole 67 and move up and down along the pole 67. The steel cylindrical float 60 is put in the pool 75 with its center fixed to the movable column 76.

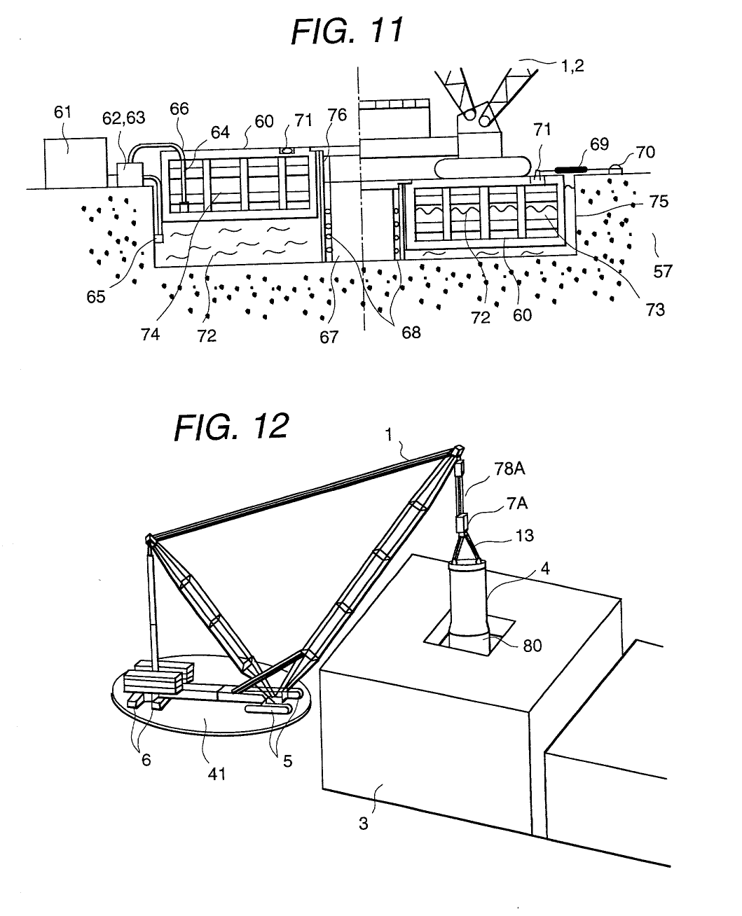

Then the pool 75 is filled with water 72 from a water storage facility 61 which is provided outside the pool through a water pipe 65 by a water pump 62. When the float 60 moves up over the ground level of the solid ground 57, a large crawler crane cannot ride onto the float 60, which is illustrated by the left half of FIG. 11.

To move the float 60 down to the ground level, water is supplied into the float through a manhole 66 on the float 60 through a water pipe 64. Water supply is stopped when the total weight of the float 60 and water supplied into the float 60 is equal to the buoyancy at the ground level (where the top of the float is as high as the ground level). In this case, the movable column 76 fixed to the float 60 moves up and down as the float 60 moves up and down and thus prevents the float from moving horizontally. Further, the movable column 76 will never go above the top of the float 60 as the movable column 76 moves up and down together as the float 60 moves.

Below will be explained a procedure to ride the two large crawler cranes 1 and 2 onto the float 60 for loading and unloading jobs, referring to right halves of FIG. 10 and FIG. 11. After the top of the float 60 matches with the ground level of the solid ground 57, the two large crawler cranes start to ride on the float 60. As the large crawler cranes 1 and 2 ride on the top of the float 60, the float 60 starts to go below the ground level because of the weights of the large crawler cranes 1 and 2. At the same time, water is pumped up from inside the float 60 though the water pipe 64 (by the pump 62).

When the front crawlers of the two large crawler cranes 1 and 2 start to ride on the float, the opposite side of the steel float 60 has a weight of the two front crawlers of the large crawler cranes. That is, the loads are clustered on one side of the float 60. To dissolve this problem, the inner space of the float can be divided into two semicircular spaces 73 and 74 to store water. The similar effect can be obtained by dividing the inner space of the float into a plurality of water storage spaces. This mechanism can control so that the buoyancy of the float may be always equal to the total weight of the two large crawler cranes and the float 60 at the ground level. In other words, the top of the float on which the large crawler cranes ride keeps at the ground level of the solid ground 57.

Next will be explained a procedure to lift and move the reactor pressure vessel 4. When the two large crawler cranes 1 and 2 start to lift the reactor pressure vessel 4 and the load on the float 60 starts to increase, the float 60 starts to go down because of shortage of buoyancy. To prevent this sinking, water is pumped up from inside the float 60 by the water pump 62 to increase the buoyancy of the float so that the top of the float 60 may always be at the ground level. In this manner, the float 60 can always keep its level at the ground level even when the load on the large crawler cranes varies.

Further, the float 60 is rotated with the reactor pressure vessel 4 suspended by the two large crawler cranes l and 2. The float 60 floating on the water 72 can be rotated with a little force. A force to rotate the float 60 in an arrow direction of FIG. 10 is given by shortening each chain block 69 which connects between each fixture 70 on the float 60 and each chain block support 70 outside the pool 75. With this, the float on the pool rotates and the two large crawler cranes 1 and 2 on the float are oriented to a selected direction.

Besides these chain blocks 69, power winches or oil-pressure (center hole) jacks can be used to give a force to rotate the float 60. The float 60 can be reverse the rotation by reconnecting the chain blocks 69 (reversing their longitudinal directions) and shortening the chain blocks 69.

When the reactor pressure vessel 4 suspended by the two large crawler cranes 1 and 2 on the float 60 comes just over the opening 80 on the top of the building 3 by such a rotation of the float, one or more of the chain blocks are reversely reconnected and shortened. This can lock the float 60 and the large crawler cranes on the float can stay there still.

Then the reactor pressure vessel 4 is lifted down onto the pedestal in the reactor building and settled on the pedestal. After the reactor pressure vessel 4 touches the pedestal, the weight of the reactor pressure vessel 4 moves from the float to the pedestal and finally the float 60 is free from the reactor pressure vessel 4 load and supports only the weight of the two large crawler cranes 1 and 2. As the result, the float starts to move up. To prevent this, water is supplied into the float 60 to reduce the buoyancy of the float 60. With this, transferring the reactor pressure vessel 4 into the reactor building 3 is completed. The above procedure is reversed to transfer the reactor pressure vessel 4 from the reactor building 3.

Although the above embodiment uses two large crawler cranes 1 and 2, only one large crawler crane can be used to transfer a lighter reactor pressure vessel 4 such as a reactor pressure vessel 4 without in-reactor pressure vessel 4 components such as a shroud.

A procedure of transferring an object by a single large crawler crane 1 on the aforesaid turn-table 41 or float 60 is the same as the above procedure using the two large crawler cranes 1 and 2 (such as rotating the turn-table 41 or the float horizontally, transferring the reactor pressure vessel 4 into the reactor building 3 as shown in FIG. 12, and taking out the object from the building). The constructions of the turn-table 41 and the float 60 for this procedure are the same as those for a procedure using the two large crawler cranes. However,the procedure using a single large crawler crane 1 does not require the hoisting apparatus 77 and the coupler of the reactor pressure vessel 4 is directly connected to the hook 7A for hoisting.

Judging from various conditions and requirements such as sizes, weights, and the number of large crawler cranes to be used and whether the reactor pressure vessel contains components such as a shroud, it is preferable that the turn-table 41 or the float 60 is 30 meters to 60 meters in diameter and can load 4,000 tons to 10,000 tons.

The above embodiment describes a working procedure to transfer the reactor pressure vessel 4 onto an installation site (e.g. pedestal) in a boiling water nuclear power plant. However, the reactor pressure vessel 4 can be substituted by another object, for example, a module assembled from construction members and apparatuses for the reactor building or the other plant product such as a reactor vessel for a pressurized water nuclear power plant.

The present invention can provide an effect of facilitating crane works in a limited narrow working space as it can rotate a crane(s) with a load in a small space without operating the crane(s).

What we claim is:

1. A loading and unloading method of rotating a turn-table on which a whole crane with a load is placed to change loading and unloading places.

2. A loading and unloading method of rotating a turn-table on which the whole cranes with a load are placed to change loading and unloading places.

3. A loading and unloading method of placing the whole crane on a float on a pool in the ground, causing said crane to hoist a load, turning said float on the pool, and thus changing loading and unloading places.

4. A loading and unloading method of placing the whole cranes sharing a load on a float on a pool in the ground, turning said float on the pool, and thus changing loading and unloading places.

5. A loading and unloading method in accordance with claim 2 or 4, wherein said method further comprises a step of balancing a common load hoisted by said plurality of cranes.

6. A loading and unloading method in accordance with claim 3 or 4, wherein said method further comprises a step of controlling the buoyancy of the float to adjust the height of the top surface of the float during the loading and unloading works.

7. A method of transferring components of a nuclear power plant, comprising the steps of installing the whole cranes on a structure which can turn horizontally, hoisting up said nuclear power plant components with said plurality of cranes, and transferring said components between the top of the building of said nuclear power plant and the outside of the building.

8. A method of transferring components of a nuclear power plant in accordance with claim 7, wherein said components are transferred into said building.

9. A method of transferring components of a nuclear power plant in accordance with claim 7, wherein said components are transferred from said building.

10. A method of transferring a nuclear reactor comprising the steps of installing the whole cranes on a structure which can horizontally rotate on a ground near a nuclear reactor building, lifting up and down said reactor in said nuclear reactor building with said plurality of cranes, and horizontally turning said structure having said plurality of cranes on it together with said nuclear reactor to horizontally transfer said nuclear reactor to the outside of said nuclear reactor building.

11. A method of transferring a nuclear reactor in accordance with claim 10, wherein said reactor is transferred into said nuclear reactor building.

12. A method of transferring a nuclear reactor in accordance with claim 10, wherein said reactor is transferred from said nuclear reactor building.

13. A crane rotating apparatus comprising a horizontally-rotatable structure on which one or more cranes are installed, wherein the structure is 30 meters to 60 meters in diameter and can load 4,000 tons to 10,000 tons.

14. A crane rotating apparatus comprising a structure whose surface is wide enough to install the whole cranes for loading and unloading, wherein said structure can rotate horizontally on the ground.

15. A crane rotating apparatus comprising a pool in a solid ground and a float which can horizontally rotate in said pool and is wide enough to have a plurality of cranes thereon.

16. A crane rotating apparatus in accordance with claim 15, wherein said float is equipped with a buoyancy control means.

17. A crane rotating apparatus in accordance with claim 16, wherein said pool comprises a post around which said float can rotate and said post can extend and shrink vertically as said float moves up and down.

18. A crane rotating apparatus in accordance with claim 15, wherein said float has areas which can individually adjust buoyancies.

19. A hoisting apparatus for cranes comprising a balance beam having at least two horizontally-spaced joints with the cranes, a hoisting rod moving unit which can move horizontally on said balance beam, a hoisting rod which is hanging from said hoisting rod moving unit, and means for driving said hoisting rod moving unit horizontally along the balance beam.

20. A hoisting apparatus for cranes in accordance with claim 19, wherein said hoisting apparatus is equipped with a remote control unit for said driving means.

21. A hoisting apparatus for cranes in accordance with claim 20, wherein said hoisting rod is provided on said hoisting rod moving unit so that the hoisting rod can rotate horizontally.
